(19) United States
(12) Patent Application Publication
(10) Pub. No.: US 2008/0025212 A1
(43) Pub. Date: Jan. 31, 2008

(54) Method and apparatus for remotely accessing resources over an insecure network

(76) Inventors: David A. George, Somers, NY (US); Hani T. Jamjoom, White Plains, NY (US); Raymond B. Jennings, Ossining, NY (US); David Safford, Brewster, NY (US)

Correspondence Address: PATTERSON & SHERIDAN LLP;IBM CORPORATION, 595 SHREWSBURY AVE, SUITE 100, SHREWSBURY, NJ, 07702, US

(21) Appl. No.: 11/495,915

(22) Filed: Jul. 28, 2006

(51) Int. Cl. H04L 12/26

(52) U.S. Cl. 370/229

(57) ABSTRACT

One embodiment of the present method and apparatus for providing access to a resource over a network includes receiving a series of packets from a sender, assessing a validity of the series of packets in accordance with expected contents of the packets and at least one expected time difference between the packets, and providing access to the resource if the series of packets is determined to be valid.

### FIELD OF THE INVENTION

The present invention relates generally to computer networks and relates more particularly to accessing network-based devices over insecure computer networks.

### BACKGROUND

Obtaining access to a resource (e.g., a physical object such as a computing device or an intangible object such as a trigger) over a network can be accomplished by standard means such as providing an interface to the resource. Traditional interfaces include some type of authentication where a user ID and/or password are solicited from the user.

Networks may be secure, insecure or something in between. For example, a secure network is one that does not run any non-essential applications, and uses authentication and encryption. An insecure network does not have any such controls and simply allows packets to be passed. Between these extremes, there exist networks that implement some, but not all, of these security controls. No network, however, is ever one hundred percent invulnerable to attacks.

A major problem occurs when a user attempts to access resources over a network that is believed to be secure, but is in actuality compromised. Moreover, hackers may exploit the interface to the user (e.g., a server-type application) as a point of attack. Even where high-grade encryption and/or authentication are implemented, the network may remain vulnerable to attacks including denial of service attacks (which can cause the network to appear unavailable) or brute force attacks (in which a hacker tries to guess a password to gain access to a network resource).

Thus, there is a need in the art for a method and apparatus for remotely accessing resources over an insecure network.

### SUMMARY OF THE INVENTION

One embodiment of the present method and apparatus for providing access to a resource over a network includes receiving a series of packets from a sender, assessing a validity of the series of packets in accordance with expected contents of the packets and at least one expected time difference between the packets, and providing access to the resource if the series of packets is determined to be valid.

### BRIEF DESCRIPTION OF THE DRAWINGS

So that the manner in which the above recited embodiments of the invention are attained and can be understood in detail, a more particular description of the invention, briefly summarized above, may be obtained by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic diagram of one embodiment of a computing network, according to the present invention;

FIG. 2 is a flow diagram illustrating one embodiment of a method for allowing access to a resource over a network, according to the present invention;

FIG. 3 is a timing diagram illustrating an exemplary transaction between a packet sender and a packet receiver, according to the present invention; and

FIG. 4 is a high level block diagram of the resource access method that is implemented using a general purpose computing device.

To facilitate understanding, identical reference numerals have been used, where possible, to designate identical elements that are common to the figures.

### DETAILED DESCRIPTION

In one embodiment, the present invention is a method and apparatus for remotely accessing resources over insecure networks. Within the context of the present invention, a resource can be either a tangible object (e.g., a computing device) or an intangible object (e.g., a service running on a computing device). In one embodiment, access to resources over a network is controlled by a combination lock-like mechanism. Access is earned by sending particular packets (e.g., with particular bit patterns) within particular time intervals. A device that listens for this combination of packets is substantially passive (i.e., does not respond to the sender of the packets); therefore, the presence of the device is difficult to detect.

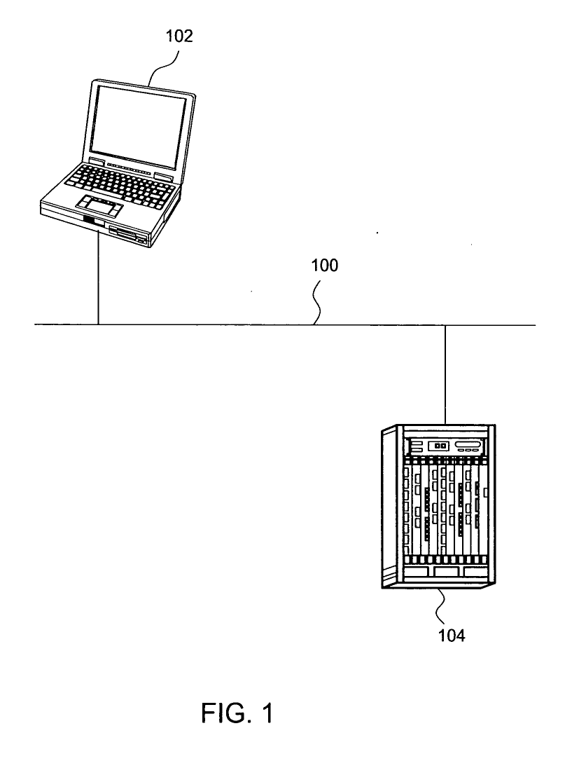

FIG. 1 is a schematic diagram of one embodiment of a computing network 100, according to the present invention. The network 100 may be a private network (e.g., a local area network (LAN) or intranet) or a public network (e.g., a wide area network (WAN) or Internet).

The network 100 includes at least one packet sender 102 and at least one packet receiver 104. The packet sender 102 may be a computing device that wishes to access a resource over the network 100. The packet sender 102 is capable of sending and receiving network packets, and may be a specific hardware device or implemented as software running on a computer.

The packet receiver 104 may be a computing device that controls access to the network 100 and its associated resources (not shown). Like the packer sender 102, the packet receiver is capable of sending and receiving network packets, and may be a specific hardware device or implemented as software running on a computer. In one embodiment described in greater detail below, however, the packet receiver 104 does not send network packets, and only receives them.

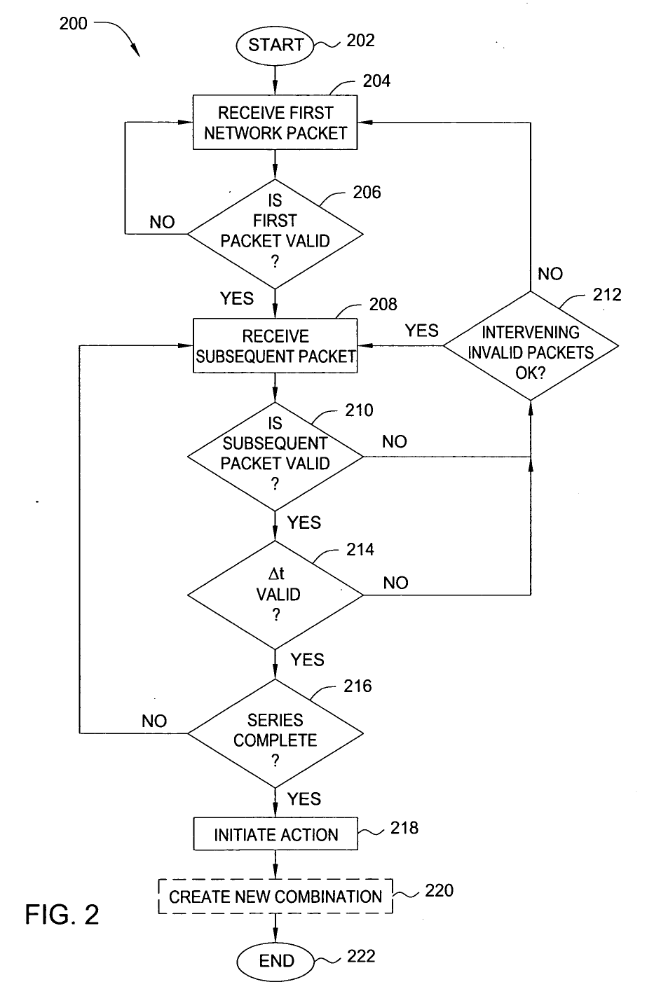

FIG. 2 is a flow diagram illustrating one embodiment of a method 200 for allowing access to a resource over a network, according to the present invention. The method 200 may be implemented, for example, at a packet receiver such as the packet receiver 104 illustrated in FIG. 1.

The method 200 is initialized at step 202 and proceeds to step 204, where a packet receiver, for example, receives a first packet from a packet sender (e.g., packet sender 102 of FIG. 1). The method 200 then proceeds to step 206 and determines whether the first packet is valid. In one embodiment, the first packet is valid if it contains an expected bit pattern. In this embodiment, the bit pattern is verified by matching zero or more bits of the bit pattern within two or more packets.

If the method 200 determines in step 206 that the first packet is not valid, the method 200 may return to step 204 and proceed as described above to await the receipt of a valid packet. Alternatively, if the method 200 determines in step 206 that the first packet is valid, the method 200 proceeds to step 208 and receives a subsequent packet from the packet sender. The method 200 then proceeds to step 210 and determines whether the subsequent packet is valid. In one embodiment, the subsequent packet is valid if it contains an expected bit pattern.

If the method 200 determines in step 210 that the subsequent packet is not valid, the method 200 proceeds to step 212 and determines whether receipt of an invalid packet should restart the method 200 (i.e., whether receipt of an intervening invalid packet between valid packets is acceptable). If the method 200 determines in step 212 that the method 200 should be restarted, the method 200 returns to step 204 and proceeds as described above to await the receipt of a first packet. Alternatively, if the method 200 determines in step 212 that the method 200 need not be restarted, the method 200 returns to step 208 and proceeds as described above to await the arrival of a subsequent packet.

If, however, the method 200 determines in step 210 that the subsequent packet is valid, the method 200 proceeds to step 214 and determines whether the difference in time (Δt) between receipt of the first packet and receipt of the subsequent packet is valid. In one embodiment, the time difference is valid if it matches an expected time difference (i.e., Δt=t_{expected}). In another embodiment, the time difference is valid if it falls within an expected range of time differences (i.e., t₁≦Δt≦t₂).

If the method 200 determines in step 214 that the time difference is invalid, then the packet is invalidated, and the method 200 returns to step 212 and proceeds as described above to determine whether the method 200 should be restarted due to receipt of the invalid packet. Alternatively, if the method 200 determines in step 214 that the time difference is valid, then the packet is validated, and the method 200 proceeds to step 216 and determines whether the received combination of packets comprises a complete series. A complete series of packets comprises an expected number of packets containing expected contents and arriving within expected time intervals. A complete series of packets may include any number of packets greater than one, but two or more packets are needed to make a combination (i.e., such that there is at least one time interval).

If the method 200 determines in step 216 that the received combination of packets is incomplete, the method 200 returns to step 208 and proceeds as described above to await receipt of a subsequent packet. Alternatively, if the method 200 determines in step 216 that the received combination of packets is complete, the method 200 proceeds to step 218 and initiates some action in response to a request of the packet sender. In one embodiment, the request is for access to a network resource, such as one or more tangible mechanical, electrical or electro-mechanical devices (e.g., electro-mechanical power switches for activating door locks and other access controls, as well as routers, switches, mainframes and other network devices) or such as the triggering of an action within the network (e.g., starting an application or service, opening a port within a computing device or network firewall or putting a computing device into maintenance mode).

The method 200 then proceeds to optional step 220 (illustrated in phantom) and generates a new packet combination (i.e., including an expected number of packets containing expected contents and expected time intervals within which the packets are to arrive). In one embodiment, the generation of a new packet combination involves simply reusing the existing packet combination. In another embodiment, the generation of a new packet combination involves using a key shared by the packet sender and a packet receiver at which the method 200 executes in order to generate a new packet combination. In this embodiment, creation and activation of the new packet combination may be performed in parallel between the packet sender and the packet receiver at which the method 200 executes. In yet another embodiment, the new packet combination is generated as an offline process. In another embodiment still, the new packet combination is generated through traditional means by transferring the new packet combination over an encrypted channel. In a further embodiment, the packet combination that was just used is disabled for any future use. The method 200 then terminates in step 222.

The method 200 therefore provides a simple means of authenticating users to a network, even where the network may be insecure. A user proves his or her authenticity by sending an expected series of packets, where each packet contains some sort of expected contents and time elapsed between the sending of the packets comprises an expected interval. Thus, the method 200 verifies both the contents of the received packets and the time spacing between the received packets. In this manner, the method 200 behaves much like a combination lock. Moreover, because no step of the method 200 requires a direct response to the packet sender, it is very difficult for an unauthorized user (e.g., a hacker) to obtain the packet combination or to even detect the presence of the device at which the method 200 executes (e.g., by performing a port scan). Thus, execution of the method 200 is substantially undetectable to observers.

Embodiments of the present invention do not maintain network connections; therefore, it is difficult for potential hackers to attack the network via SYN flood attacks. Moreover, embodiments of the method 200 accommodate invalid packets that may arrive intermixed with packets that are part of the packet combination required to access network resources. The packet combination may specify that these invalid packets be discarded, or alternatively may specify that receipt of an invalid packet invalidates the entire access attempt (i.e., the packet sender must start over with the first packet). In further embodiments, the packet combination specifies a limit on a number of invalid packets that may be received within a single access attempt.

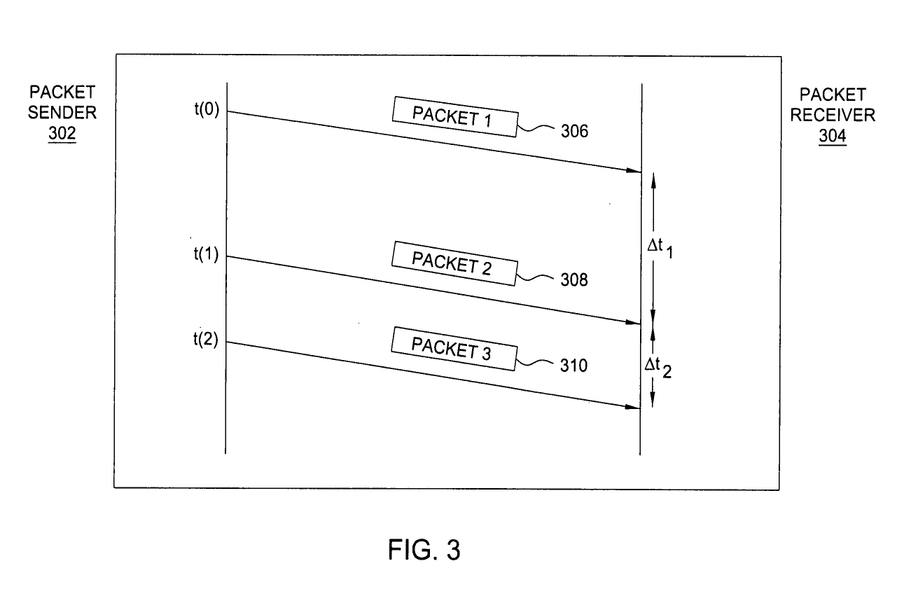

FIG. 3 is a timing diagram illustrating an exemplary transaction 300 (i.e., the sending of a packet combination) between a packet sender 302 and a packet receiver 304, according to the present invention. As illustrated a first packet 306 is sent by the packet sender 302 to the packet receiver 304 at time t(0). The contents of the first packet 306 are consistent with a bit pattern that is known to both the packet sender 302 and the packet receiver 304.

A second packet 308 is sent from the packet sender 302 to the packet receiver 304 at time t(1). When the packet receiver 304 receives the second packet 308, the packet receiver 304 computes a first time difference, Δt₁, where Δt₁, =t(1)−t(0). At], either matches an expected value or falls within an expected range that is known to both the packet sender 302 and the packet receiver 304. In addition, the contents of the second packet 308 are consistent with a bit pattern that is known to both the packet sender 302 and the packet receiver 304.

A third packet 310 is sent from the packet sender 302 to the packet receiver 304 at time t(2). When the packet receiver 304 receives the third packet 310, the packet receiver 304 computes a second time difference, Δt₂, where Δt₂=t(2)−t(1). At, either matches an expected value or falls within an expected range that is known to both the packet sender 302 and the packet receiver 304. In addition, the contents of the third packet 310 are consistent with a bit pattern that is known to both the packet sender 302 and the packet receiver 304. If the first packet 306, second packet 308, third packet 310, first time difference and second time difference are all consistent with what is know to the packet sender 302 and the packet receiver 304, then the packet receiver 304 takes appropriate action to grant the packet sender 302 access to a requested network resource.

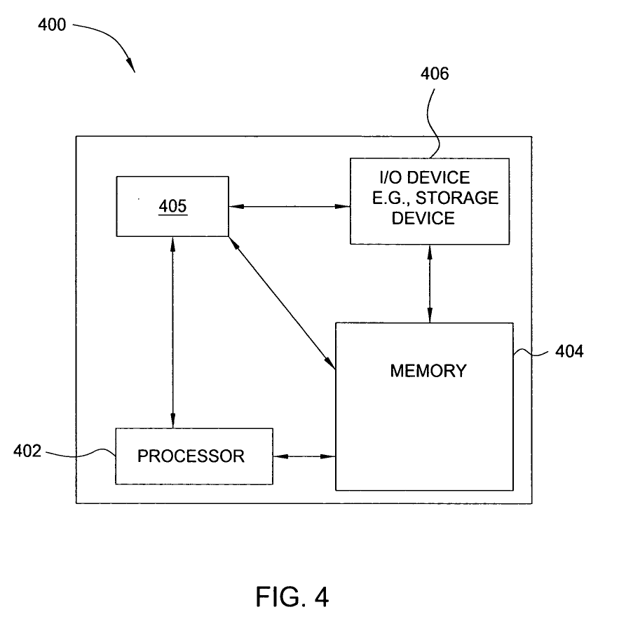

FIG. 4 is a high level block diagram of the resource access method that is implemented using a general purpose computing device 400. In one embodiment, a general purpose computing device 400 includes a processor 402, a memory 404, a resource access module 405 and various input/output (I/O) devices 406 such as a display, a keyboard, a mouse, a modem, and the like. In one embodiment, at least one I/O device is a storage device (e.g., a disk drive, an optical disk drive, a floppy disk drive). It should be understood that the resource access module 405 can be implemented as a physical device or subsystem that is coupled to a processor through a communication channel.

Alternatively, the resource access module 405 can be represented by one or more software applications (or even a combination of software and hardware, e.g., using Application Specific Integrated Circuits (ASIC)), where the software is loaded from a storage medium (e.g., I/O devices 406) and operated by the processor 402 in the memory 404 of the general purpose computing device 400. Thus, in one embodiment, the resource access module 405 for accessing resources over a network described herein with reference to the preceding Figures can be stored on a computer readable medium or carrier (e.g., RAM, magnetic or optical drive or diskette, and the like).

Moreover, those skilled in the art will appreciate that the methods described herein may be embodied in a service whereby access to resources in a customer computing network is controlled by monitoring and analyzing packet combinations that are received from would-be users of the customer network.

Thus, the present invention represents a significant advancement in the field of computer networks. A method and apparatus are provided that enable access to resources over a (potentially insecure) network through use of a combination lock-like mechanism. Access is earned by sending particular packets (e.g., with particular bit patterns) within particular time intervals. A device that listens for this combination of packets is substantially passive (i.e., does not respond to the sender of the packets); therefore, the presence of the device is difficult to detect.

While the foregoing is directed to the preferred embodiment of the present invention, other and further embodiments of the invention may be devised without departing from the basic scope thereof, and the scope thereof is determined by the claims that follow.

1. A method for providing access to a resource over a network, said method comprising:
receiving a series of packets from a sender;
assessing a validity of the series of packets in accordance with expected contents of the packets and at least one expected time difference between the packets; and
providing access to the resource if the series of packets is determined to be valid.

2. The method of claim 1, wherein said assessing comprises:
determining that the series of packets is valid if the expected contents and the at least one expected time difference are found therein.

3. The method of claim 1, wherein the assessing comprises:
examining each packet in the series of packets for a respective expected bit pattern; and
examining each pair of sequential valid packets in the series of packets for a respective expected time difference therebetween.

4. The method of claim 3, wherein the assessing further comprises:
examining the series of packets to determine that the series is complete in accordance with an expected series of packets, the expected series of packets comprising two or more packets including respective expected bit patterns and an expected time difference between the two or more packets.

5. The method of claim 1, wherein the at least one expected time difference is valid if it matches an expected time difference.

6. The method of claim 1, wherein the at least one expected time difference is valid if it falls within a range of expected time differences.

7. The method of claim 1, wherein the series of packets includes at least one packet that is discarded.

8. The method of claim 1, wherein the resource comprises at least one: mechanical resource, electrical resource or electro-mechanical resource.

9. The method of claim 1, wherein the providing comprises: triggering an occurrence of at least one action in the network or on a computer in the network.

10. The method of claim 1, further comprising:
generating a new expected series of packets, the new expected series of packets comprising two or more packets having expected contents at least one expected time difference between the two or more packets, the new expected series of packets being generated for use by the sender in future attempts to access a resource over the network.

11. The method of claim 10, wherein the generating is performed in accordance with a key shared by the sender.

12. The method of claim 10, wherein the generating comprises reusing a previously used expected series of packets.

13. The method of claim 10, wherein the generating is performed as an offline process.

14. The method of claim 10, wherein the new expected series of packets is forwarded to the sender over an encrypted channel.

15. The method of claim 1, further comprising:
disabling the series of packets such that the series of packets cannot be used in connection with a future attempt to access a resource over the network.

16. A computer readable medium containing an executable program for providing access to a resource over a network, where the program performs the steps of:
receiving a series of packets from a sender;
assessing a validity of the series of packets in accordance with expected contents of the packets and at least one expected time difference between the packets; and providing access to the resource if the series of packets is determined to be valid.

17. The computer readable medium of claim 16, wherein said assessing comprises:
determining that the series of packets is valid if the expected contents and the at least one expected time difference are found therein.

18. The computer readable medium of claim 16, wherein the assessing comprises:
examining each packet in the series of packets for a respective expected bit pattern; and
examining each pair of sequential valid packets in the series of packets for a respective expected time difference therebetween.

19. Apparatus for providing access to a resource over a network, said apparatus comprising:
means for receiving a series of packets from a sender;
means for assessing a validity of the series of packets in accordance with expected contents of the packets and at least one expected time difference between the packets; and
means for providing access to the resource if the series of packets is determined to be valid.

20. A method for controlling access to resources in a customer computing network, the method comprising:
receiving a series of packets from a sender, the sender requesting access to at least one of the resources in the customer computing network;
assessing a validity of the series of packets in accordance with expected contents of the packets and at least one expected time difference between the packets; and
providing access to the at least one of the resources if the series of packets is determined to be valid.
